(19) United States
(12) Patent Application Publication
(10) Pub. No.: US 2008/0170484 A1
(43) Pub. Date: Jul. 17, 2008

(54) Optical recording medium

(75) Inventors: Koji Mishima, Tokyo (JP); Takashi Kikukawa, Tokyo (JP); Hidetake Itoh, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/003,916

(22) Filed: Jan. 3, 2008

(30) Foreign Application Priority Data
Jan. 15, 2007 (JP) 2007-6478

(51) Int. Cl. G11B 7/00

(52) U.S. Cl. 369/94; 369/100

(57) ABSTRACT

A reliable optical recording medium is provided which includes an information layer exhibiting small changes in the optical properties even during long-term storage. The optical recording medium includes the information layer including a recording film having an extinction coefficient of 0.4 or less at the wavelength of a laser beam used for recording and reproducing. The information layer further includes a light absorbing film having an extinction coefficient of 1.5 or less at the wavelength of the laser beam, and the extinction coefficient of the light absorbing film is greater than that of the recording film.

### BACKGROUND OF THE INVENTION

1. Field of the Invention

The present invention relates to an optical recording medium in which a blue or blue-violet laser beam is used for recording and reproducing.

2. Description of the Related Art

Optical recording media such as CDs (Compact Discs) and DVDs (Digital Versatile Discs) have been widely utilized as information recording media. In addition, in recent years, the use of optical recording media known as Blu-ray Discs (registered trademark) and HD DVDs (registered trademark) has become widespread. In such optical recording media, a blue or blue-violet laser beam having a wavelength of 405 nm (within the range of 375 to 435 nm) is used for recording and reproducing, so that a larger amount of information can be recorded in comparison to conventional media. Note that, in such optical recording media, tracks are formed with a track pitch within the range of 0.1 to 0.5 μm, and more specifically, with a track pitch of 0.32 μm for Blu-ray Discs and 0.40 μm for HD DVDs.

Optical recording media are broadly classified into a ROM (Read Only Memory) type to which data cannot be added or rewritten, a rewritable type to which data can be rewritten, and a write-once type to which data can be written only once.

In write-once type optical recording media, data is recorded by projecting a laser beam onto an information layer to form recording marks which have a reflectivity that is different from that of a space portion therearound. At the same time, the space portion around each recording mark is also irradiated with the recording laser beam. However, since the amount of the recording laser beam projected onto the space portion is small, the reflectivity of the space portion is the same as the reflectivity of the information layer before it was irradiated with the laser beam. Moreover, in the write-once type optical recording media, data is reproduced by projecting a laser beam onto the information layer and detecting the difference in reflectivity between the recording mark and the space portion therearound using a photodetector.

In some cases, the information layer is composed of a recording film only. However, in most cases, in addition to the recording film, a dielectric film for protecting the recording film is provided on one side or both sides of the recording film. When the information layer has, in addition to the recording film, an additional layer such as the dielectric film described above, a material having an extinction coefficient which is less than that of the recording film is often used as the material forming the additional layer in order to reduce the amount of the laser beam that is absorbed by the additional layer as much as possible. For example, the extinction coefficient of the material used to form the recording film is in the range of approximately 0.5 to 3.0, and a material having an extinction coefficient in the range of approximately 0.00 to 0.10 is often used as the material forming the dielectric layer.

In addition, a reflective layer is often provided on the side of the information layer located furthest away from the laser beam incident surface. A metal such as Al or Ag is often used as the material forming the reflective layer, and the extinction coefficient of the material forming the reflective layer is 2.0 or more.

It is important for the recording film of a write-once type optical recording medium that not only its optical properties are changed by laser beam irradiation but that the recording film is not likely to deteriorate during long-term storage and that it exhibits excellent durability. Hence, conventionally, an organic dye has been widely used as the material for the recording film for write-once type CDs and DVDs. A conventional organic dye such as that mentioned above is a material which does not absorb a large amount of ultraviolet radiation or short wavelength visible light such as blue light or blue-violet light which easily facilitate a chemical reaction. This property contributes to suppress any deterioration of the recording film.

However, as such a conventional organic dye does not absorb a large amount of blue to blue-violet visible light with short wavelengths, when a blue or blue-violet laser beam is used for recording, any changes in the optical properties of the dye are insufficient, and therefore data cannot be recorded. In addition, it is difficult to develop an organic dye which exhibits sufficient changes in its optical properties even when a blue or blue-violet laser beam is used for recording and which is also less likely to deteriorate during long-term storage.

In view of this, write-once type optical recording media are known in which an inorganic material is used as the material forming the recording film (see, for example, Japanese Patent Application Laid-Open Nos. 2003-48375 and Hei 10-334507).

A particular type of such an inorganic material exhibits sufficient changes in its optical properties even when a blue or blue-violet laser beam is used for recording. In addition to this, such an inorganic material is less likely to deteriorate during long-term storage when compared to the conventional organic dyes and is therefore expected to provide excellent durability. For this reason, in optical recording media known as Blu-ray Discs, an optical recording media in which such an inorganic material is used as the material forming the recording film, are becoming widespread.

However, even in the recording film of such an inorganic material, the optical properties of the information layer may deteriorate during long-term storage. For example, the light absorption characteristics of the information layer can change during long-term storage.

The recording density of optical recording media known as Blu-ray discs and HD DVDs is high, and as such, high recording/reproducing accuracy is required. Therefore, it is desirable to suppress such a change in the optical properties of the information layer as much as possible.

### SUMMARY OF THE INVENTION

In view of the foregoing problems, various exemplary embodiments of this invention provide a reliable optical recording medium which includes an information layer which exhibits only small changes in its optical properties even during long-term storage.

Various exemplary embodiments of the invention achieve the foregoing object by an optical recording medium including an information layer including a recording film having an extinction coefficient of 0.4 or less at a wavelength of a laser beam used for recording and reproducing, the information layer further including a light absorbing film having an extinction coefficient of 1.5 or less at the wavelength of the laser beam, wherein the extinction coefficient of the light absorbing film is greater than that of the recording film.

The present inventors have first attempted to develop a recording film material which exhibits only small changes in its optical properties, such as the amount of light absorption, even during long-term storage. However, the inventors have recognized that it is difficult to develop a recording film material which exhibits sufficient changes in its optical properties even when a blue or blue-violet laser beam is used as the irradiation light beam and which also exhibits only small changes in its optical properties even during long-term storage.

The present inventors have made further intensive studies and have consequently arrived at a conception of various exemplary embodiments of the present invention. Specifically, the information layer includes a recording film and a light absorbing film wherein the light absorbing film has an extinction coefficient that is greater than that of the recording film.

By providing both the recording film and also the light absorbing film which has an extinction coefficient that is greater than that of the recording film in the information layer as described above, both the light absorbing film together and the recording film play a role in light absorption in the information layer. Therefore, even when the amount of light absorption in the recording film is changed during long-term storage, any change in the amount of light absorption in the information layer as a whole is smaller than that in an information layer in which only a recording film plays a major role in light absorption. Accordingly, the changes in the optical properties of the information layer are suppressed.

Moreover, the light absorbing film is not required to play a role in information recording. Therefore, the material forming the light absorbing film may be selected from various materials which exhibit a small change in the amount of light absorption during long-term storage.

Furthermore, since the extinction coefficient of the recording film is 0.4 or less, the ratio of the amount of light absorption in the recording film to that in the information layer as a whole is small. Therefore, the effect of suppressing the changes in the optical properties of the information layer is high. Even when the amount of light absorption in the recording film is small, the light absorbing film absorbs light so that the light for forming good recording marks in the recording film can be absorbed in the information layer as a whole. As the extinction coefficient of the recording film increases, the thickness of the light absorbing film must be increased correspondingly in order to ensure that the effect of the light absorbing film is retained. When the extinction coefficient of the recording film is excessively large, the thickness of the light absorbing film must be increased to an extent that is not easily attainable in a practical design. However, since the extinction coefficient of the recording film is 0.4 or less, a suitable light absorbing film is easily designed.

In addition to this, when the extinction coefficient of the light absorbing film is excessively large, the variations in the amount of light absorption caused by variations in the thickness of the light absorbing film can be significantly large. Therefore, the light absorbing film must be deposited to a desirable thickness with high precision and it may, in practice, be difficult to deposit such a light absorbing film. However, since the extinction coefficient of the light absorbing film is 1.5 or less, a suitable light absorbing film can be easily deposited.

As described above, in various exemplary embodiments of the invention, the information layer includes a recording film and a light absorbing film which has an extinction coefficient that greater than that of the recording film. The information layer is configured such that the recording film mainly plays a role in information recording and the light absorbing film mainly plays a role in light absorption. In this manner, any changes in the optical properties of the information layer can be suppressed, and in addition to this, good recording marks can be formed in the information layer. Thus, various exemplary embodiments of the present invention have been achieved based on a concept that is different from the concept used in the conventional technology. In the conventional technology, only the recording film usually plays a major role in light absorption, and, when the information layer includes, in addition to the recording film, an additional layer such as a dielectric film, the extinction coefficient of the additional layer is usually less than that of the recording film.

Accordingly, various exemplary embodiments of this invention provide an optical recording medium comprising: an information layer including a recording film having an extinction coefficient of 0.4 or less at a wavelength of a laser beam used for recording and reproducing, wherein the information layer further includes a light absorbing film having an extinction coefficient of 1.5 or less at the wavelength of the laser beam, the extinction coefficient of the light absorbing film being greater than that of the recording film.

In the present application, the expression “the recording film consists essentially of Bi, O, and M” means that the ratio of the total number of Bi, O, and M atoms in the recording film to the number of all the atoms constituting the recording film is 80% or more. When the recording film consists essentially of Bi, O, and M, it is more preferable that the total number of Bi, O, and M atoms in the recording film be 90% or more of the number of all the atoms constituting the recording film.

Furthermore, in the present application, the expression “the recording film consists essentially of Bi and O” means that the total number of Bi and O atoms in the recording film to the number of all the atoms constituting the recording film is 80% or more. When the recording film consists essentially of Bi and O, it is more preferable that the total number of Bi and O atoms in the recording film to the number of all the atoms constituting the recording film be 90% or more.

According to the present invention, a reliable optical recording medium can be provided which includes an information layer exhibiting small changes in the optical properties even during long-term storage.

### BRIEF DESCRIPTION OF THE DRAWINGS

FIG. 1 is a cross-sectional side view schematically illustrating the structure of an optical recording medium according to a first exemplary embodiment of the present invention;

FIG. 2 is an enlarged cross-sectional side view schematically illustrating the structure of an information layer of the optical recording medium of FIG. 1;

FIG. 3 is an enlarged cross-sectional side view schematically illustrating the structure of an information layer of an optical recording medium according to a second exemplary embodiment of the present invention; and

FIG. 4 is an enlarged cross-sectional side view schematically illustrating the structure of an information layer of an optical recording medium according to a third exemplary embodiment of the present invention.

### DETAILED DESCRIPTION OF THE PREFERRED EMBODIMENTS

Hereinafter, preferred exemplary embodiments of the present invention will be described in detail with reference to the drawings.

An optical recording medium 10 according to a first exemplary embodiment of the present invention has a disc-like shape having an outer diameter of approximately 120 mm and a thickness of approximately 1.2 mm, and in this instance, a blue or blue-violet laser beam having a wavelength of approximately 405 nm (within the range of 375 to 435 nm) is used for recording and reproducing.

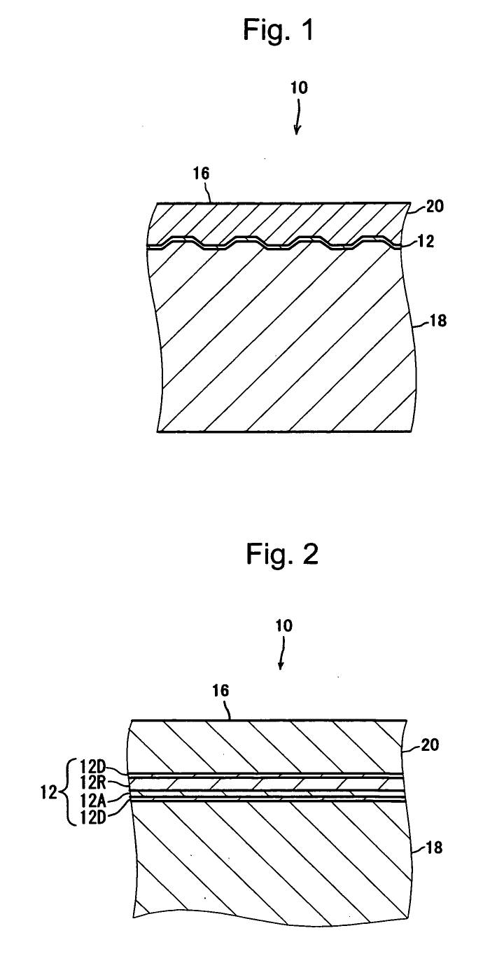

As shown in FIGS. 1 and 2, the optical recording medium 10 includes an information layer 12 including a recording film 12R which has an extinction coefficient of 0.4 or less at the wavelength of the laser beam used for recording and reproducing. The information layer 12 further includes a light absorbing film 12A which has an extinction coefficient of 1.5 or less at the wavelength of the laser beam, and the extinction coefficient of the light absorbing film 12A is greater than that of the recording film 12R.

In the optical recording medium 10, the relationship represented by the following inequality (I) is satisfied:

(k_{A}×t_{A})/(k_{R}×t_{R})>0.35 (I)

wherein k_{R} is the extinction coefficient of the recording film 12R, t_{R} is the thickness of the recording film 12R, k_{A} is the extinction coefficient of the light absorbing film 12A, and t_{A} is the thickness of the light absorbing film 12A.

Preferably, in the optical recording medium 10, the relationship represented by the following inequality (III) is satisfied:

(k_{A}×t_{A})/(k_{R}×t_{R})>1.1 (III)

The descriptions of other components will be omitted as appropriate because they do not seem to be particularly important for an understanding of the first exemplary embodiment.

The information layer 12 is formed over a substrate 18, and a cover layer 20 is formed over the information layer 12 on the side opposite to the substrate 18 side. The optical recording medium 10 is configured such that the laser beam for recording and reproducing is projected onto an incident surface 16 of the cover layer 20 on the side opposite to the substrate 18 side.

A material having an extinction coefficient k_{R} of 0.4 or less at a wavelength in the range of 375 to 435 nm is used as the material for the recording film 12R. For example, as the material forming the recording film 12R, any suitable material may be used which consists essentially of Bi, O, and M (M is at least one element selected from the group consisting of Fe, Ge, Sb, Mg, Ca, Zr, Nb, Zn, Al, Si, Na, K, Sn, Y, Dy, Ce, Tb, Ti, V, Ta, Mo, W, Mn, In, Li, Sr, Ba, Sc, La, Nd, Sm, Gd, Ho, Cr, Co, Ni, Cu, Ga, and Pb) and in which the ratio of the number of O atoms to the total number of all the atoms constituting the material is 62% or more. Preferably, a material which consists essentially of Bi, O, and M (M is at least one element selected from the group consisting of Mg, Ca, Ti, Zr, Nb, Zn, Al, Si, Ge, Sn, Sb, Na, and K) and in which the ratio of the number of O atoms to the total number of all the atoms constituting the material is 62% or more may be used as the material forming the recording film 12R. In this case, the extinction coefficient can be reduced, and a recording film having a small absorption amount can be provided.

Also, a material which consists essentially of Bi and O and in which the ratio of the number of O atoms to the total number of all the atoms constituting the material is 62% or more may be used as the material forming the recording film 12R.

Preferably, in the recording film 12R, the relationship represented by the following inequality (II) is satisfied:

k_{R}×t_{R}<7 nm (II)

Moreover, the thickness t_{R} of the recording film 12R is preferably 10 to 50 nm.

The light absorbing film 12A is disposed so as to come into contact with a surface of the recording film 12R on the substrate 18 side. Preferably, a material having an extinction coefficient of 0.3 or more at the wavelength within the range of 375 to 435 nm is used as the material forming the light absorbing film 12A. Preferably, the material forming the light absorbing film 12A has a thermal conductivity of 30 W/(mK) in a bulk state. Preferably, the material forming the light absorbing film 12A is an oxide. Specific examples of the material forming the light absorbing film 12A include Fe₂O₃, V₂O₃, V₂O₅, MnO₂, lower oxides such as AlOₓ (0.3<x<1.4), lower nitrides such as AlNₓ (0.2<x<0.9), and FeS. The thickness of the light absorbing film 12A is preferably in the range of 1 to 40 nm.

The information layer 12 further includes two dielectric films 12D. One of the dielectric films 12D is disposed so as to come into contact with a surface of the light absorbing film 12A on the substrate 18 side. The other is disposed so as to come into contact with a surface of the recording film 12R on the cover layer 20 side. The extinction coefficient of two dielectric films 12D is less than 0.3. Examples of the material forming the dielectric films 12D include oxides such as TiO₂, SiO₂, Al₂O₃, ZnO, CeO₂, and Ta₂O₅, nitrides such as SiN, AlN, GeN, and GeCrN, sulfides such as ZnS, and materials containing a mixture thereof, such as a mixture of ZnS and SiO₂, as a main component. The thickness of each of the two dielectric films 12D is preferably in the range of 2 to 20 nm.

The substrate 18 has a thickness of approximately 1.1 mm, and a concavo-convex pattern constituting grooves is formed on its surface on the cover layer 20 side. The term “grooves” is generally used to refer to recessed portions used for data recording and reproducing. However, for convenience, in the present application, when portions used for data recording and reproducing are protruding portions protruding toward the cover layer 20 side, the term “grooves” is also used to include the protruding portions. In the first exemplary embodiment, protruding portions toward the cover layer 20 side are the grooves. The grooves are formed with a track pitch within the range of 0.1 to 0.5 μm. Examples of the material forming the substrate 18 include polycarbonate resins, acrylic resins, epoxy resins, polystyrene resins, polyethylene resins, polypropylene resins, silicone resins, fluorine-based resins, ABS resins, and urethane resins. The information layer 12 is formed in a concavo-convex pattern following the concavo-convex pattern of the substrate 18.

The cover layer 20 has a thickness of, for example, 30 to 150 μm. Examples of the material forming the cover layer 20 include energy ray-curable transparent or translucent resins such as acrylic-based UV curable resins and epoxy-based UV curable resins. As used herein, the term “energy ray” is used to refer to a generic term of, for example, electromagnetic waves and particle beams, such as ultraviolet rays and electron beams, having the ability to cure a particular resin in a fluid state. As a method for forming the cover layer 20, a resin having fluidity may be applied to the substrate and then cured by projecting energy rays thereonto, or a transparent or translucent film prepared in advance may be applied to the substrate.

A description will now be given of the function of the optical recording medium 10.

In the optical recording medium 10, the information layer 12 includes the recording film 12R and the light absorbing film 12A which has an extinction coefficient that is greater than that of the recording film 12R. Furthermore, the extinction coefficient k_{R} of the recording film 12R, the thickness t_{R} of the recording film 12R, the extinction coefficient k_{A} of the light absorbing film 12A, and the thickness t_{A} of the light absorbing film 12A satisfy the inequality (I) detailed above. Therefore, both the recording film 12R and the light absorbing film 12A play a role in light absorption in the information layer 12. Accordingly, even if the amount of light absorption in the recording film 12R changes during long-term storage, a change in the amount of light absorption in the information layer 12 as a whole is smaller than that in an information layer in which only a recording film plays a major role in light absorption. Hence, any changes in the optical properties of the information layer are suppressed.

Moreover, since the light absorbing film 12A is not required to play a role in information recording, the material forming the light absorbing film 12A can be selected from various materials which exhibit a small change in the amount of light absorption even during long-term storage. By employing such a material as the material forming the light absorbing film 12A, the effect of suppressing any changes in the optical properties of the information layer 12 can be enhanced.

Furthermore, the recording film 12R has an extinction coefficient of 0.4 or less, and the ratio of the amount of light absorption in the recording film 12R to that in the information layer 12 as a whole is small. Therefore, the effect of suppressing any changes in the optical properties of the information layer 12 is high. Note that even when the amount of light absorption in the recording film 12R is small, the light absorbing film 12A absorbs light so that the light for forming good recording marks in the recording film 12R can be absorbed in the information layer 12 as a whole. Moreover, as the extinction coefficient of the recording film 12R increases, the thickness of the light absorbing film 12A must be increased correspondingly in order to ensure that the effect of the light absorbing film 12A is retained. When the extinction coefficient of the recording film 12R is excessively large, the thickness of the light absorbing film 12A must be increased to an extent that is not easily attainable in a practical design. However, since the extinction coefficient of the recording film 12R is 0.4 or less, a suitable light absorbing film is easily designed.

Furthermore, when the extinction coefficient of the light absorbing film 12A is excessively large, the variations in the amount of light absorption caused by variations in the thickness of the light absorbing film 12A are significantly large. Therefore, the light absorbing film 12A must be deposited to a thickness which is precisely controlled to an extent that is not easily attainable in practice. However, since the extinction coefficient of the light absorbing film 12A is 1.5 or less, a suitable light absorbing film 12A can be easily deposited.

In addition, materials having an excessively large extinction coefficient, such as metal materials, often have a high thermal conductivity. Hence, when such a material having a high thermal conductivity is used as the material forming the light absorbing film 12A, heat is easily transferred to the area surrounding an irradiated area in the information layer 12, and therefore the formation of good recording marks may be somewhat inhibited.

However, by employing as the material forming the light absorbing film 12A a material having an extinction coefficient k_{A} of 1.5 or less and a thermal conductivity of 30 W/(mK) or less, good recording marks can be formed in the information layer 12.

A description will now be given of a second exemplary embodiment of the present invention.

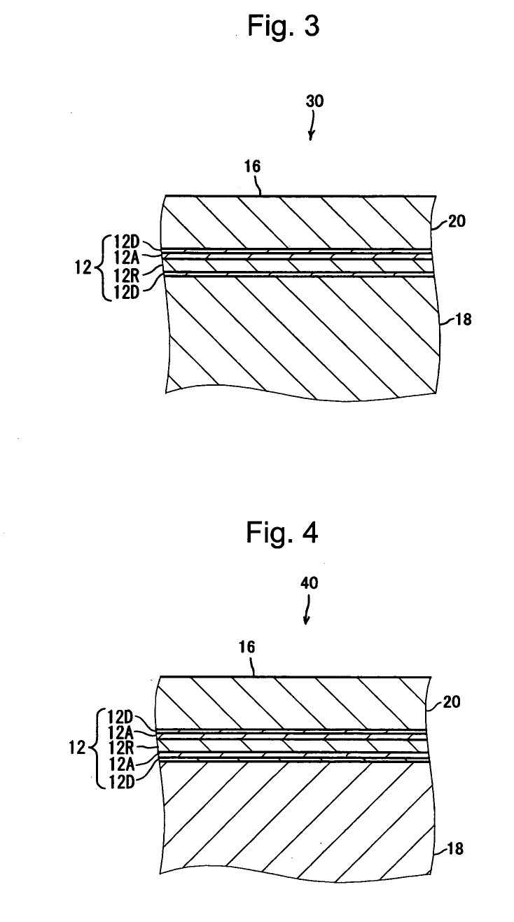

In the optical recording medium 10 according to the first exemplary embodiment, the light absorbing film 12A is disposed so as to come into contact with a surface of the recording film 12R on the substrate 18 side. However, an optical recording medium 30 according to a second exemplary embodiment is characterized in that the light absorbing film 12A is disposed so as to come into contact with a surface of the recording film 12R on the cover layer 20 side as shown in FIG. 3. Since other components are the same as those of the optical recording medium 10, the same reference numerals as in FIGS. 1 and 2 are used, and a redundant description is omitted.

As described above, the light absorbing film 12A is disposed so as to come into contact with the surface of the recording film 12R on the cover layer 20 side. Even in this case, both the light absorbing film 12A and the recording film 12R play a role in light absorption in the information layer 12, as in the case in which the light absorbing film 12A is disposed so as to come into contact with the surface of the recording film 12R on the substrate 18 side. Therefore, even if the amount of light absorption in the recording film 12R changes, a change in the amount of light absorption in the information layer 12 as a whole is smaller than that in an information layer in which only a recording film plays a major role in light absorption. Accordingly, the changes in the optical properties of the information layer are suppressed.

A description will now be given of a third exemplary embodiment of the present invention.

In the optical recording media 10 and 30 according to the first and second exemplary embodiments, respectively, the light absorbing film 12A is disposed so as to come into contact with one surface of the recording film 12R. However, an optical recording medium 40 according to the third exemplary embodiment is characterized in that the light absorbing film 12A is disposed on both sides of the recording film 12R so as to come into contact therewith as shown in FIG. 4. Since other components are the same as those of the optical recording media 10 and 30, the same reference numerals as in FIGS. 1, 2 and 3 are used, and a redundant description is omitted.

As described above, the light absorbing film 12A is disposed on both the sides of the recording film 12R so as to come into contact therewith. Even in this case, both the light absorbing films 12A and the recording film 12R play a role in light absorption in the information layer 12, as in the case in which the light absorbing film 12A is disposed so as to come into contact with one surface of the recording film 12R. Therefore, even if the amount of light absorption in the recording film 12R changes, a change in the amount of light absorption in the information layer 12 as a whole is smaller than that in an information layer in which only a recording film plays a major role in light absorption. Accordingly, the changes in the optical properties of the information layer are suppressed.

In the first to third exemplary embodiments, the materials that consist essentially of Bi, O, and M and the materials that consist essentially of Bi and O are exemplified as the material for the recording film 12R. However, any material may be used as the material forming the recording film 12R so long as it has a small extinction coefficient of 0.4 or less.

Moreover, in the first to third exemplary embodiments, the light absorbing film 12A comes into contact with the recording film 12R. However, another layer, such as a dielectric layer, having an extinction coefficient that is less than that of the recording film 12R may be formed between the light absorbing film 12A and the recording film 12R.

Furthermore, in the configuration of each of the first to third exemplary embodiments, the information layer 12 comes into direct contact with the substrate 18. However, a reflective layer may be provided between the information layer 12 and the substrate 18. As the material forming the reflective layer, Al, Ag, Au, Cu, Mg, Ti, Cr, Fe, Co, Ni, Zn, Ge, Pt, Pd or an alloy thereof may be used. Of these, Al, Ag, Au, Cu, or an alloy such as AgPdCu is preferably used since a high reflectivity can be obtained. In addition, a dielectric material can be used as the material forming the reflective layer.

Moreover, in each of the first to third exemplary embodiments, the information layer 12 includes the two dielectric films 12D. However, one or both of the dielectric films may be omitted.

Furthermore, in each of the first to third exemplary embodiments, an example of the optical recording medium of a single layer recording type is shown. However, various exemplary embodiments of the present invention are suitable for, for example, an optical recording medium having two or more recording films.

Moreover, in each of the first to third exemplary embodiments, an example of the optical recording medium having the recording film only on one side of the substrate is shown. However, various exemplary embodiments of the present invention are of course applicable to an optical recording medium having a recording film on both sides of a substrate.

Furthermore, in the first to third exemplary embodiments, each of the optical recording media 10, 30, and 40 has the structure of a Blu-ray Disc in which the cover layer 20 is thinner than the substrate 18. However, various exemplary embodiments of the present invention are applicable to an optical recording medium in which the thickness of a cover layer is the same as that of a substrate as in an HD DVD. In such a case, the shape of the cover layer is substantially the same as the shape of the substrate. However, in the present application, one irradiated with the laser beam for recording and reproducing is referred to as the cover layer.

### Working Example 1

Samples A to D each having a configuration the same as that of the optical recording medium 10 of the first exemplary embodiment were manufactured. The configuration of the information layer 12 of each of the samples A to D is shown in Table 1. In each of the samples A to D, the thickness of the substrate 18 was 1.1 mm, and the thickness of the cover layer 20 was 100 μm.

TABLE 1

| | | | | Light absorbing film | | | Recording film | | |
|---|---|---|---|---|---|---|---|---|---|
| | Dielectric film | | | | Extinction | | | Extinction | |
| | | Extinction | Thickness | | coefficient | Thickness | | coefficient | Thickness |
| Sample | Material | coefficient | (nm) | Material | k_{A} | t_{A}(nm) | Material | k_{R} | t_{R}(nm) |
| A | TiO₂ | 0.05 | 5 | Fe₂O₃ | 0.8 | 5 | Bi:Fe:O = 25:5:70 | 0.28 | 38 |
| B | TiO₂ | 0.05 | 5 | Fe₂O₃ | 0.8 | 5 | Bi:Ge:O = 28:2:70 | 0.18 | 38 |
| C | TiO₂ | 0.05 | 5 | Fe₂O₃ | 0.8 | 5 | Bi:Ge:O = 21:10:69 | 0.08 | 38 |
| D | TiO₂ | 0.05 | 5 | V₂O₅ | 0.5 | 8 | Bi:Ge:O = 21:10:69 | 0.08 | 38 |

| | | | | | | | Before high | | | |
|---|---|---|---|---|---|---|---|---|---|---|
| | | | | | | | temperature | | | |
| | | | | | | | and high | | After high | |
| | | | | | | | humidity | | temperature | |
| | | | | | | | treatment | | and high humidity | |
| | Dielectric film | | | | | | Optimal | | treatment | |
| | | Extinction | Thickness | K_{A} × t_{A} | K_{R} × t_{R} | (k_{A} × t_{A})/ | recording | Jitter | Recording power | Jitter |
| Sample | Material | coefficient | (nm) | (nm) | (nm) | (k_{R} × k_{R}) | power (mW) | (%) | (mW) | (%)) |
| A | TiO₂ | 0.05 | 10 | 4.00 | 10.64 | 0.38 | 3.6 | 5.7 | 3.6 | 7.8 |
| B | TiO₂ | 0.05 | 10 | 4.00 | 6.84 | 0.58 | 4.8 | 5.2 | 4.8 | 6.0 |
| C | TiO₂ | 0.05 | 10 | 4.00 | 3.04 | 1.32 | 4.8 | 5.1 | 4.8 | 5.6 |
| D | TiO₂ | 0.05 | 10 | 4.00 | 3.04 | 1.32 | 5.0 | 5.2 | 5.0 | 5.8) |

The films constituting the information layer 12 are disposed from the substrate side to the cover layer side in the order shown in Table 1 (from left to right). This is also the case in each of Tables 2 to 6 described later.

First, the optimal recording power and jitter of each of the samples A to D were measured. Subsequently, a high temperature and high humidity treatment was applied to each of the samples A to D. Specifically, each of the samples A to D was placed in a high temperature and high humidity environment (a temperature of 80° C. and a relative humidity of 85%). After each of the samples A to D was placed in the high temperature and high humidity environment for approximately 50 hours, recording marks were formed in the information layer 12 of each of the samples A to D at a recording power that was the same as that used before each sample was placed in the high temperature and high humidity environment, and the jitter was measured again. The measurement results are also shown in Table 1. The optimal recording power was measured before each of the samples A to D was placed in the high temperature and high humidity environment by means of the following method. First, a laser beam having a wavelength of 405 nm was projected onto each of the samples at various powers to form recording marks in the information layer 12. Next, the jitter value of each of the recording marks was measured by means of a recording/reproducing apparatus. Since the output power level of the laser beam used for forming a recording mark which has the lowest jitter value is suitable for the output level of the laser beam for the corresponding sample, this output level was employed as the optimal recording power. In this instance, the output level of the laser beam was determined by converting the intensity of the laser beam on the incident surface 16 to an electrical power.

The extinction coefficient of the recording film 12R of each of the samples A to D was measured as follows. First, a film having a composition the same as that of the recording film 12R of each of the samples A to D was deposited to a thickness of 70 nm on a flat polycarbonate substrate having no grooves formed thereon. Next, the extinction coefficient of each of the films at a wavelength of 405 nm was determined by means of ETA-RT (product of STEAG ETA-Optik).

### Working Example 2

Samples E to H were manufactured. In contrast to the optical recording medium 10 of the first exemplary embodiment, in the configuration of each of the samples E to H, a dielectric film was formed between the light absorbing film 12A and the recording film 12R. The dielectric film had an extinction coefficient which is less than that of the recording film 12R. The configuration of the information layer 12 of each of the samples E to H is shown in Table 2. The other components of each of the samples E to H are the same as those of each of the samples A to D of Working Example 1.

TABLE 2

| | | | | Light absorbing film | | | | | | |
|---|---|---|---|---|---|---|---|---|---|---|
| | Dielectric film | | | | Extinction | | Dielectric film | | | |
| | | Extinction | Thickness | | coefficient | Thickness | | Extinction | Thickness | Recording film |
| Sample | Material | coefficient | (nm) | Material | k_{A} | t_{A}(nm) | Material | coefficient | (nm) | Material |
| E | TiO₂ | 0.05 | 5 | Fe₂O₃ | 0.8 | 5 | TiO₂ | 0.05 | 5 | Bi:Ge:O = 21:10:69 |
| F | TiO₂ | 0.05 | 5 | Fe₂O₃ | 0.8 | 5 | TiO₂ | 0.05 | 5 | Bi:Sb:O = 21:11:68 |
| G | TiO₂ | 0.05 | 5 | Fe₂O₃ | 0.8 | 5 | TiO₂ | 0.05 | 5 | Bi:Mg:O = 20:11:69 |
| H | TiO₂ | 0.05 | 5 | Al₇₂Cr₉O₁₁ | 1.4 | 3 | TiO₂ | 0.05 | 5 | Bi:Ge:O = 21:10:69 |

| | | | | | | | | | Before high | | | |
|---|---|---|---|---|---|---|---|---|---|---|---|---|
| | | | | | | | | | temperature | | After high | |
| | | | | | | | | | and high | | temperature | |
| | | | | | | | | | humidity | | and high | |
| | | | | | | | | | treatment | | humidity | |
| | Recording film | | | | | | | | Optimal | | treatment | |
| | Extinction | | Dielectric film | | | | | | recording | | Recording | |
| | coefficient | Thickness | | Extinction | Thickness | K_{A} × t_{A} | K_{R} × t_{R} | (k_{A} × t_{A})/ | power | Jitter | power | Jitter |
| Sample | k_{R} | t_{R}(nm) | Material | coefficient | (nm) | (nm) | (nm) | (k_{R} × k_{R}) | (mW) | (%) | (mW) | (%) |
| E | 0.08 | 38 | TiO₂ | 0.05 | 10 | 4.00 | 3.04 | 1.32 | 4.9 | 4.9 | 4.9 | 4.9 |
| F | 0.08 | 38 | TiO₂ | 0.05 | 10 | 4.00 | 3.04 | 1.32 | 4.8 | 5.4 | 4.8 | 5.5 |
| G | 0.09 | 38 | TiO₂ | 0.05 | 10 | 4.00 | 3.42 | 1.17 | 4.7 | 5.9 | 4.7 | 6.1 |
| H | 0.08 | 38 | TiO₂ | 0.05 | 10 | 4.20 | 3.04 | 1.38 | 6.1 | 5.3 | 6.1 | 5.4 |

As in Working Example 1, the optimal recording power and jitter of each of the samples E to H were measured before the samples were placed in the high temperature and high humidity environment. Furthermore, after each sample was placed in the high temperature and high humidity environment, recording marks were formed in the information layer 12 at a recording power which was the same as the corresponding optimal recording power measured before the each sample was placed in the high temperature and high humidity environment. Then, the jitter was measured again. The measurement results are also shown in Table 2.

In addition to this, samples were manufactured in each of which the constituent element Sb of the recording film of the sample F was replaced with Ca, Zr, Nb, Zn, Al, Si, Ge, Na, K, or Sn while the ratio of the number of atoms remained unchanged, and the optimal recording power and jitter were measured. The optimal recording power and jitter of each of these samples were substantially the same as those of the sample F.

### Working Example 3

Sample J of the optical recording medium having a configuration which was the same as that of the optical recording medium 30 of the second exemplary embodiment was manufactured. The configuration of the information layer 12 of the sample J is shown in Table 3. The other components are the same as those of each of samples A to D of Working Example 1.

TABLE 3

| | | | | Recording film | | | Light absorbing film | | |
|---|---|---|---|---|---|---|---|---|---|
| | Dielectric film | | | | Extinction | | | Extinction | |
| | | Extinction | Thickness | | coefficient | Thickness | | coefficient | Thickness |
| Sample | Material | coefficient | (nm) | Material | k_{R} | t_{R}(nm) | Material | k_{A} | t_{A}(nm) |
| J | TiO₂ | 0.05 | 5 | Bi:Ge:O = 21:10:69 | 0.08 | 38 | Fe₂O₃ | 0.8 | 5 |

| | | | | | | | Before high | | | |
|---|---|---|---|---|---|---|---|---|---|---|
| | | | | | | | temperature | | | |
| | | | | | | | and high | | After high | |
| | | | | | | | humidity | | temperature and | |
| | | | | | | | treatment | | high humidity | |
| | Dielectric film | | | | | | Optimal | | treatment | |
| | | Extinction | Thickness | K_{A} × t_{A} | K_{R} × t_{R} | (k_{A} × t_{A})/ | recording | Jitter | Recording power | Jitter |
| Sample | Material | coefficient | (nm) | (nm) | (nm) | (k_{R} × k_{R}) | power (mW) | (%) | (mW) | (%) |
| J | TiO₂ | 0.05 | 10 | 4.00 | 3.04 | 1.32 | 5.5 | 5.3 | 5.5 | 5.8 |

As in Working Example 1, the optimal recording power and jitter of the samples J were measured before the sample was placed in the high temperature and high humidity environment. Furthermore, after the sample J was placed in the high temperature and high humidity environment, recording marks were formed in the information layer 12 at a recording power which was the same as the optimal recording power measured before the sample was placed in the high temperature and high humidity environment. Then, the jitter was measured again. The measurement results are also shown in Table 3.

### Comparative Example 1

Sample K of the optical recording medium was manufactured in which the light absorbing film 12A in Working Example 1 was omitted. The configuration of the information layer of the sample K is shown in Table 4. The other components are the same as those of each of the samples A to D of Working Example 1.

TABLE 4

| | | | | Light absorbing film | | | Recording film | | |
|---|---|---|---|---|---|---|---|---|---|
| | Dielectric film | | | | Extinction | | | Extinction | |
| | | Extinction | Thickness | | coefficient | Thickness | | coefficient | Thickness |
| Sample | Material | coefficient | (nm) | Material | k_{A} | t_{A}(nm) | Material | k_{R} | t_{R}(nm) |
| K | TiO₂ | 0.05 | 5 | — | — | — | Bi:Fe:O = 25:5:70 | 0.28 | 38 |

| | | | | | | | Before high | | | |
|---|---|---|---|---|---|---|---|---|---|---|
| | | | | | | | temperature | | | |
| | | | | | | | and high | | After high | |
| | | | | | | | humidity | | temperature and | |
| | | | | | | | treatment | | high humidity | |
| | Dielectric film | | | | | | Optimal | | treatment | |
| | | Extinction | Thickness | K_{A} × t_{A} | K_{R} × t_{R} | (k_{A} × t_{A})/ | recording | Jitter | Recording power | Jitter |
| Sample | Material | coefficient | (nm) | (nm) | (nm) | (k_{R} × k_{R}) | power (mW) | (%) | (mW) | (%) |
| K | TiO₂ | 0.05 | 10 | 0 | 10.64 | 0.00 | 4.8 | 5.6 | 4.8 | 19.5 |

As in Working Example 1, the optimal recording power and jitter of the sample K were measured before the sample was placed in the high temperature and high humidity environment. Furthermore, after the sample K was placed in the high temperature and high humidity environment, recording marks were formed in the information layer 12 at a recording power which was the same as the optimal recording power measured before the sample was placed in the high temperature and high humidity environment. Then, the jitter was measured again. The measurement results are also shown in Table 4.

### Comparative Example 2

Sample L was manufactured in which, in contrast to Working Example 1, the thickness t_{A} of the light absorbing film 12A was reduced and (k_{R}×t_{R})/(k_{R}×t_{R}) was 0.23 (being less than 0.3). The configuration of the information layer of the sample L is shown in Table 5. The other components are the same as those of each of the samples A to D of Working Example 1.

TABLE 5

| | | | | Light absorbing film | | | Recording film | | |
|---|---|---|---|---|---|---|---|---|---|
| | Dielectric film | | | | Extinction | | | Extinction | |
| | | Extinction | Thickness | | coefficient | Thickness | | coefficient | Thickness |
| Sample | Material | coefficient | (nm) | Material | k_{A} | t_{A}(nm) | Material | k_{R} | t_{R}(nm) |
| L | TiO₂ | 0.05 | 5 | Fe₂O₃ | 0.8 | 3 | Bi:Fe:O = 25:5:70 | 0.28 | 38 |

| | | | | | | | Before high | | | |
|---|---|---|---|---|---|---|---|---|---|---|
| | | | | | | | temperature | | | |
| | | | | | | | and high | | After high | |
| | | | | | | | humidity | | temperature and | |
| | | | | | | | treatment | | high humidity | |
| | Dielectric film | | | | | | Optimal | | treatment | |
| | | Extinction | Thickness | K_{A} × t_{A} | K_{R} × t_{R} | (k_{A} × t_{A})/ | recording | Jitter | Recording power | Jitter |
| Sample | Material | coefficient | (nm) | (nm) | (nm) | (k_{R} × k_{R}) | power (mW) | (%) | (mW) | (%) |
| L | TiO₂ | 0.05 | 10 | 2.4 | 10.64 | 0.23 | 4.2 | 5.7 | 4.2 | 10.2 |

As in Working Example 1, the optimal recording power and jitter of the sample L were measured before the sample was placed in the high temperature and high humidity environment. Furthermore, after the sample L was placed in the high temperature and high humidity environment, recording marks were formed in the information layer 12 at a recording power which was the same as the optimal recording power measured before the sample was placed in the high temperature and high humidity environment. Then, the jitter was measured again. The measurement results are also shown in Table 5.

### Comparative Example 3

Sample M was manufactured in which, in contrast to Working Example 3, an AgPdCu alloy having an extinction coefficient k_{A} of 2.1 (being greater than 1.5) was used as the material for the light absorbing film. The configuration of the information layer of the sample M is shown in Table 6. The other components are the same as those of the sample J of Working Example 3.

TABLE 6

| | | | | Light absorbing film | | | | | | |
|---|---|---|---|---|---|---|---|---|---|---|
| | Dielectric film | | | | Extinction | | Dielectric film | | | |
| | | Extinction | Thickness | | coefficient | Thickness | | Extinction | Thickness | Recording film |
| Sample | Material | coefficient | (nm) | Material | k_{A} | t_{A}(nm) | Material | coefficient | (nm) | Material |
| M | TiO₂ | 0.05 | 5 | AgPdCu | 2.1 | 2 | TiO₂ | 0.05 | 5 | Bi:Ge:O = 21:10:69 |

| | | | | | | | | | Before high | | After high | |
|---|---|---|---|---|---|---|---|---|---|---|---|---|
| | | | | | | | | | temperature | | temperature | |
| | | | | | | | | | and high | | and high | |
| | | | | | | | | | humidity | | humidity | |
| | | | | | | | | | treatment | | treatment | |
| | Recording film | | | | | | | | Optimal | Record- | | |
| | Extinction | | Dielectric film | | | | | | recording | | ing | |
| | coefficient | Thickness | | Extinction | Thickness | K_{A} × t_{A} | K_{R} × t_{R} | (k_{A} × t_{A})/ | power | Jitter | power | Jitter |
| Sample | k_{R} | t_{R}(nm) | Material | coefficient | (nm) | (nm) | (nm) | (k_{R} × k_{R}) | (mW) | (%) | (mW) | (%) |
| M | 0.08 | 38 | TiO₂ | 0.05 | 10 | 4.20 | 3.04 | 1.38 | 6.8 | 10.5 | 6.8 | 15.7 |

As in Working Example 3, the optimal recording power and jitter of the samples M were measured before the sample was placed in the high temperature and high humidity environment. Furthermore, after the sample M was placed in the high temperature and high humidity environment, recording marks were formed in the information layer 12 at a recording power which was the same as the optimal recording power measured before the sample was placed in the high temperature and high humidity environment. Then, the jitter was measured again. The measurement results are also shown in Table 6.

As shown in Table 4, in the sample K of Comparative Example 1, the jitter was 5.6%, which is much less than 8%, for the recording marks formed at the optimal recording power before the sample was placed in the high temperature and high humidity environment, so that excellent reproducing characteristics were obtained. However, after the sample was placed in the high temperature and high humidity environment, the jitter was 19.5%, which is much greater than 8%, for the recording marks formed in the information layer 12 at a recording power which was the same as the optimal recording power measured before the sample was placed in the high temperature and high humidity environment. Namely, excellent reproducing characteristics were not obtained. This may be because the amount of light absorption in the recording film was changed after the sample K was placed in the high temperature and high humidity environment and as such, since the information layer was not provided with the light absorbing film, the change in the amount of light absorption in the recording film was directly reflected on the change in the amount of light absorption in the information layer as a whole.

As shown in Table 5, in the sample L of Comparative Example 2 also, the jitter was 5.7%, which is much less than 8%, for the recording marks formed at the optimal recording power before the sample was placed in the high temperature and high humidity environment, so that excellent reproducing characteristics were obtained. However, after the sample was placed in the high temperature and high humidity environment, the jitter was 10.2%, which is much greater than 8%, for the recording marks formed in the information layer 12 at a recording power which was the same as the optimal recording power measured before the sample was placed in the high temperature and high humidity environment. Namely, excellent reproducing characteristics were not obtained. This may be because, although the information layer included the light absorbing film, the value of (k_{A}×t_{A})/(k_{R}×t_{R}) was 0.23, which is less than 0.35, and as such, the ratio of the amount of light absorption in the light absorbing film to the amount of light absorption in the information layer as a whole was low, so that the effect of providing the light absorbing film was low.

As shown in Table 6, in the sample M of Comparative Example 3, the jitter was 10.5%, which is much greater than 8%, for the recording marks formed at the optimal recording power before the sample was placed in the high temperature and high humidity environment. In addition to this, after the sample was placed in the high temperature and high humidity environment, the jitter was 15.7%, which is much greater than 8%, for the recording marks formed in the information layer 12 at a recording power which was the same as the optimal recording power measured before the sample was placed in the high temperature and high humidity environment. Namely, in both cases, good reproducing characteristics were not obtained. The reason that the jitter value measured before the sample was placed in the high temperature and high humidity environment was also poor was that the level of noise was large. This may be because, since the thickness of the dielectric film disposed between the recording film and the light absorbing film made of AgPdCu was small, the light absorbing film was partially oxidized during deposition of the recording film. In addition to this, the optimal recording power was high, or at least exceeded 6 mW. This may be because, since the light absorbing film was formed from a metal having a high thermal conductivity, heat was transferred in excessive amounts to the surrounding areas of the portions irradiated with the recording laser beam in the information layer to increase the optimal recording power.

On the other hand, as shown in Tables 1 to 3, the extinction coefficient of the light absorbing film of each of the samples A to H and J of Working Examples 1 to 3 was approximately 1.5 or less, and more specifically, was in the range of 0.5 to 1.4. In each of the samples A to H and J, the jitter was much less than 8% for the recording marks formed at the optimal recording power before the sample was placed in the high temperature and high humidity environment. Furthermore, even after the sample was placed in the high temperature and high humidity environment, the jitter was much less than 8% for the recording marks formed in the information layer 12 at a recording power whish was the same as the optimal recording power measured before the sample was placed in the high temperature and high humidity environment. Namely, excellent reproducing characteristics were obtained in both cases.

In addition, the difference between the jitter of the recording marks recorded before each sample was placed in the high temperature and high humidity environment and the jitter of the recording marks recorded after each sample was placed in the high temperature and high humidity environment was small.

It was found that the difference between the jitter of the recording marks recorded before each sample was placed in the high temperature and high humidity environment and the jitter of the recording marks recorded after each sample was placed in the high temperature and high humidity environment tends to decrease as the value of (k_{A}×t_{A})/(k_{R}×t_{R}) increases.

In the samples A to H and J of Working Examples 1 to 3, the values of (k_{A}×t_{A})/(k_{R}×t_{R}) were in the range of 0.38 to 1.38. Therefore, it was found that, when the value of (k_{A}×t_{A})/(k_{R}×t_{R}) is greater than approximately 0.35, the difference between the jitter of the recording marks recorded before the sample was placed in the high temperature and high humidity environment and the jitter of the recording marks recorded after the sample was placed in the high temperature and high humidity environment is reduced to a small value.

In the samples C to H, the value of (k_{A}×t_{A})/(k_{R}×t_{R}) was in the range of 1.17 to 1.38. In each of these samples, the difference between the jitter of the recording marks recorded before the sample was placed in the high temperature and high humidity environment and the jitter of the recording marks recorded after the sample was placed in the high temperature and high humidity environment was reduced to 0.5% or less. This was considered to be particularly good. That is, it was found that when the value of (k_{A}×t_{A})/(k_{R}×t_{R}) is greater than approximately 1.1, the difference between the jitter of the recording marks recorded before the sample was placed in the high temperature and high humidity environment and the jitter of the recording marks recorded after the sample was placed in the high temperature and high humidity environment is reduced to 0.5% or less. This is excellent.

In addition to this, it was found that the difference between the jitter of the recording marks recorded before the sample was placed in the high temperature and high humidity environment and the jitter of the recording marks recorded after the sample was placed in the high temperature and high humidity environment tends to decrease as the value of (k_{R}×t_{R}) decreases. In the samples B to H and J, the value of (k_{R}×t_{R}) was in the range of 3.04 to 6.84 nm. In each of the samples, the difference between the jitter of the recording marks recorded before the sample was placed in the high temperature and high humidity environment and the jitter of the recording marks recorded after the sample was placed in the high temperature and high humidity environment was reduced to 1.0% or less. That is, it was found that, when the value of (k_{R}×t_{R}) is less than approximately 7 nm, the difference between the jitter of the recording marks recorded before the sample was placed in the high temperature and high humidity environment and the jitter of the recording marks recorded after the sample was placed in the high temperature and high humidity environment is reduced to 1.0% or less.

What is claimed is:

1. An optical recording medium comprising:
an information layer including a recording film having an extinction coefficient of 0.4 or less at a wavelength of a laser beam used for recording and reproducing, wherein
the information layer further includes a light absorbing film having an extinction coefficient of 1.5 or less at the wavelength of the laser beam, the extinction coefficient of the light absorbing film being greater than that of the recording film.

2. The optical recording medium according to claim 1, wherein the extinction coefficient of the light absorbing film is 0.3 or more.

3. The optical recording medium according to claim 1, wherein following inequality (I) is satisfied:
(k_{A}×t_{A})/(k_{R}×t_{R})>0.35 (I)
wherein k_{R} is the extinction coefficient of the recording film, t_{R} is a thickness of the recording film, k_{A} is the extinction coefficient of the light absorbing film, and t_{A} is a thickness of the light absorbing film.

4. The optical recording medium according to claim 2, wherein following inequality (I) is satisfied:
(k_{A}×t_{A})/(k_{R}×t_{R})>0.35 (I)
wherein k_{R} is the extinction coefficient of the recording film, t_{R} is a thickness of the recording film, k_{A} is the extinction coefficient of the light absorbing film, and t_{A} is a thickness of the light absorbing film.

5. The optical recording medium according to claim 1, wherein the light absorbing film has a thermal conductivity of 30 W/(mK) or less in a bulk state.

6. The optical recording medium according to claim 2, wherein the light absorbing film has a thermal conductivity of 30 W/(mK) or less in a bulk state.

7. The optical recording medium according to claim 3, wherein the light absorbing film has a thermal conductivity of 30 W/(mK) or less in a bulk state.

8. The optical recording medium according to claim 1, wherein the light absorbing film is made of an oxide.

9. The optical recording medium according to claim 2, wherein the light absorbing film is made of an oxide.

10. The optical recording medium according to claim 3, wherein the light absorbing film is made of an oxide.

11. The optical recording medium according to claim 5, wherein the light absorbing film is made of an oxide.

12. The optical recording medium according to claim 1, wherein a relationship represented by following inequality (II) is satisfied:
k_{R}×t_{R}<7 nm (II)
wherein k_{R} is the extinction coefficient of the recording film, and t_{R} is a thickness of the recording film.

13. The optical recording medium according to claim 2, wherein a relationship represented by following inequality (II) is satisfied:
k_{R}×t_{R}<7 nm (II)
wherein k_{R} is the extinction coefficient of the recording film, and t_{R} is a thickness of the recording film.

14. The optical recording medium according to claim 3, wherein a relationship represented by following inequality (II) is satisfied:
k_{R}×t_{R}<7 nm (II)
wherein k_{R} is the extinction coefficient of the recording film, and t_{R} is a thickness of the recording film.

15. The optical recording medium according to claim 5, wherein a relationship represented by following inequality (II) is satisfied:
k_{R}×t_{R}<7 nm (II)
wherein k_{R} is the extinction coefficient of the recording film, and t_{R} is a thickness of the recording film.

16. The optical recording medium according to claim 8, wherein a relationship represented by following inequality (II) is satisfied:
k_{R}×t_{R}<7 nm (II)
wherein k_{R} is the extinction coefficient of the recording film, and t_{R} is a thickness of the recording film.

17. The optical recording medium according to claim 1, wherein the recording film consists essentially of Bi, O, and M where M is at least one element selected from the group consisting of Fe, Ge, Sb, Mg, Ca, Zr, Nb, Zn, Al, Si, Na, K, Sn, Y, Dy, Ce, Tb, Ti, V, Ta, Mo, W, Mn, In, Li, Sr, Ba, Sc, La, Nd, Sm, Gd, Ho, Cr, Co, Ni, Cu, Ga, and Pb, and a ratio of number of O atoms to number of all atoms constituting the recording film is 62% or more.

18. The optical recording medium according to claim 1, wherein the recording film consists essentially of Bi and O, and a ratio of number of O atoms to number of all atoms constituting the recording film is 62% or more.

19. The optical recording medium according to claim 1, wherein the wavelength of the laser light used for recording and reproducing is in range of 375 to 435 nm.

20. The optical recording medium according to claim 1, wherein tracks where recording marks are to be formed are formed with a track pitch within range of 0.1 to 0.5 μm.
